(19) United States
(12) Patent Application Publication
(10) Pub. No.: US 2023/0299714 A1
(43) Pub. Date: Sep. 21, 2023

(54) SOLAR ARRAY DUST REMOVAL

(71) Applicant: Maxar Space LLC, Palo Alto, CA (US)

(72) Inventors: Harry A. Yates, Mountain View, CA (US); Roselin Campos, San Jose, CA (US)

(73) Assignee: Maxar Space LLC, Palo Alto, CA (US)

(21) Appl. No.: 17/698,437

(22) Filed: Mar. 18, 2022

(51) Int. Cl. H02S 40/10; B08B 7/02; B08B 7/04; B08B 13/00; B06B 1/06; H02S 30/20

(52) U.S. Cl. CPC H02S 40/10; B08B 7/02; B08B 7/04; B08B 13/00; B06B 1/0629; H02S 30/20; B06B 2201/70

(57) ABSTRACT

Described herein are apparatuses and methods for use therewith that can be used to remove dust and other types of particulates from a solar array of a spacecraft, a lander, a rover, or the like. Such an apparatus can include a main body and a solar array extending from the main body. One or more piezoelectric devices is/are attached to the solar array. The piezoelectric device(s), when activated, is/are configured to vibrate at least a portion of the solar array to thereby loosen particulates adhered thereto. The apparatus also includes one or more linear actuators that when actuated is/are configured to at least one of bump against, push on, or pull on at least a portion of the solar array to thereby jettison from the solar array at least some of the particulates that were loosened by the one or more piezoelectric devices.

### FIELD

Embodiments described herein relate to the field of spacecraft, such as satellites, and other types of non-Earth apparatuses, such as rovers, and landers, that have solar arrays that are used to power the non-Earth apparatuses.

### BACKGROUND

Solar cells, which are also known as photovoltaic cells, are semiconductor devices that converts photons into electricity. Solar cells generate charge carriers (electrons and holes) in a light absorbing material. Solar cells separate the charge carriers to conductive contacts that transmit electricity. This conversion is called the photovoltaic effect, and the field of research related to solar cells is known as photovoltaics. A solar array is a collection or arrangement of solar cells.

To provide operating power, satellites and other spacecraft use solar arrays with a large surface area of photovoltaic cells to generate electricity from the sunlight incident on the array structure. Solar arrays have been used and are planned to be used in space missions. Such missions can involve satellites or other types of spacecraft that orbit the Earth, as well as spacecraft that are intended to land on the Earth's moon, another planet (e.g., Mars), or an asteroid, just to name a few. In particular, space satellites and other types of spacecraft used in space missions have utilized solar arrays to provide power from sunlight for powering devices, such telecommunication devices, thrusters, and rovers, just to name a few. For purposes of discussion, the term “outer space” means space outside of the Earth's atmosphere. Further, the term “non-Earth application” means any device or system that is designed to function in outer space or on an extraterrestrial body such as a moon, a planet, or an asteroid.

Solar cells may be grouped together to form arrays and an array or arrays may be arranged as desired on a solar panel. The solar panels, in turn, may be arranged in an array. Dust settling on the solar arrays obscures the light and therefore reduces the amount of electricity that the solar arrays produce.

Solar arrays operating on or near celestial bodies with dusty environments, such as the Earth's moon, Mars, asteroids, etc., can collect dust which obscures the photovoltaics resulting in reduced efficiency, reduced power output and increased temperature, all of which are undesirable. Further, if dust and/or other types of particulates collect on a deployed solar array that is intended to be re-stowed and thereafter re-deployed, the particulates can abrade the solar array, or a glass covering thereof, which can cause further obscuration and/or damage to the solar array and/or the glass covering thereof, which is also undesirable.

### BRIEF SUMMARY

Certain embodiments of the present technology are directed to an apparatus including a solar array, one or more piezoelectric devices attached to the solar array, and one or more linear actuators. The one or more piezoelectric devices, when activated, is/are configured to vibrate at least a portion of the solar array to thereby loosen particulates adhered thereto. The one or more linear actuators, when actuated, is/are configured to at least one of bump against, push on, or pull on at least a portion of the solar array to thereby jettison from the solar array at least some of the particulates that were loosened by the one or more piezoelectric devices. The apparatus can be, for example, a spacecraft configured to land on a moon, a planet, or an asteroid, wherein such a spacecraft can also be referred to as a lander. Alternatively, the apparatus can be a spacecraft configured to orbit a moon or a planet, wherein such a spacecraft can be a satellite, a shuttle, a space station, an inter-planet traveling craft, or a rocket, but is not limited thereto. In still other embodiments, the apparatus can be a rover configured to drive on a moon, a planet, or an asteroid. In certain embodiments the apparatus includes a main body from with the solar array extends, wherein the main body can be a portion of a spacecraft, a rover, or a lander, but is not limited thereto. In still other embodiments, the apparatus can be a stand-alone solar array.

In accordance with certain embodiments, the one or more linear actuators is/are each configured to linearly actuate in a respective direction generally perpendicular to a major planar surface of the solar array.

In accordance with certain embodiments, the one or more linear actuators include a first linear actuator and a second linear actuator, wherein the first linear actuator is configured to bump against, push on, or pull on a first portion of the solar array, and the second linear actuator is configured to bump against, push on, or pull on a second portion of the solar array, so that a tortional force is exerted on the solar array.

In accordance with certain embodiments, the apparatus further comprises a controller configured to selectively activate the one or more piezoelectric devices and to selectively actuate the one or more linear actuators. In certain such embodiments, the controller is configured to activate the one or more piezoelectric devices at one or more frequencies within a first frequency range, and to actuate the one or more linear actuators at one or more frequencies within a second frequency range that is less than the first frequency range. In certain embodiments, the controller is configured to activate the one or more piezoelectric devices during a first period of time and to actuate the one or more linear actuators during a second period of time that follows the first period of time. Alternatively, the controller is configured to activate the one or more piezoelectric devices and to actuate the one or more linear actuators during a same period of time.

In accordance with certain embodiments, the controller is configured to selectively activate the one or more piezoelectric devices and to selectively actuate the one or more linear actuators so that an increase in an amount of power collected by the solar array, which results from the jettison of the at least some of the particulates from the solar array, exceeds an amount of power consumed to activate the one or more piezoelectric devices and to actuate the one or more linear actuators.

In accordance with certain embodiments, the solar array comprises a flexible blanket solar array that is supported by a frame, and the one or more linear actuators, when actuated, is/are configured to at least one of bump against, push on, or pull on one or more portions of the frame that supports the flexible blanket solar array. In other embodiments the solar array comprises a plurality of rigid or semi-rigid solar panels that are coupled to one another by flexible or semi-flexible hinges.

Certain embodiments of the present technology are directed to methods for removing particulates from a solar array that, for example, extends from a main body of a spacecraft, a rover, or a lander. Such a method can include vibrating at least a portion of the solar array, using one or more piezoelectric devices attached to the solar array, to thereby loosen particulates that had adhered to the solar array. The method can also include at least one of bumping against, pushing on, or pulling on at least a portion of the solar array, using one or more linear actuators, to thereby jettison from the solar array at least some of the particulates that were loosened by the one or more piezoelectric devices.

In accordance with certain embodiments, the at least one of bumping against, pushing on, or pulling on a portion of the solar array, using the one or more linear actuators, is performed in a respective direction generally perpendicular to a major planar surface of the solar array.

In accordance with certain embodiments, the one or more linear actuators include a first linear actuator and a second linear actuator. In certain such embodiments, at least one of bumping against, pushing on, or pulling on a first portion of the solar array is performed using the first linear actuator, and at least one of bumping against, pushing on, or pulling on a second portion of the solar array is performed using the second linear actuator, so that a tortional force is exerted on the solar array.

In accordance with certain embodiments, the vibrating is performed by activating the one or more piezoelectric devices at one or more frequencies within a first frequency range, and the at least one of bumping against, pushing on, or pulling on a portion of the solar array is performed by actuating the one or more linear actuators at one or more frequencies within a second frequency range that is less than the first frequency range.

In accordance with certain embodiments, the vibrating is performed by activating the one or more piezoelectric devices during a first period of time, and the at least one of bumping against, pushing on, or pulling on a portion of the solar array is performed by actuating the one or more linear actuators during a second period of time that follows the first period of time.

In accordance with certain embodiments, the vibrating and the at least one of bumping against, pushing on, or pulling on a portion of the solar array are performed during a same period of time by activating the one or more piezoelectric devices and actuating the one or more linear actuators during the same period of time.

In accordance with certain embodiments, the vibrating and the at least one of bumping against, pushing on, or pulling on a portion of the solar array are selectively performed so that an increase in an amount of power collected by the solar array, which results from the jettison of the at least some of the particulates from the solar array, exceeds an amount of power consumed to activate the one or more piezoelectric devices and to actuate the one or more linear actuators.

In accordance with certain embodiments, the solar array comprises a flexible blanket solar array that is supported by a frame, and the portion of the solar array, upon which the at least one of bumping against, pushing on, or pulling on occurs, comprises the frame that supports the flexible blanket solar array. In accordance with other embodiments, the solar array comprises a plurality of rigid or semi-rigid solar panels that are coupled to one another by flexible or semi-flexible hinges.

An apparatus according to an embodiment of the present technology comprises a flexible blanket solar array, a frame that supports the flexible solar array blanket, a plurality of piezoelectric devices attached to the flexible solar array blanket, and one or more linear actuators positioned so that the one or more linear actuators each linearly actuate in a respective direction generally perpendicular to a major planar surface of the solar array, and such that each can at least one of bump against, push on, or pull on the frame that supports the flexible solar array blanket. The apparatus also comprises a controller configured to cause selective activation of the plurality of piezoelectric devices attached to the solar array to thereby vibrate at least a portion of the solar array to thereby loosen particulates adhered thereto. The controller is also configured to cause selective actuation of the one or more linear actuators so that the one or more linear actuators at least one of bump against, push on, or pull on the frame that supports the flexible solar array blanket to thereby jettison from the flexible solar array blanked at least some of the particulates that were loosened by the plurality of piezoelectric devices.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate the same or similar elements.

FIG. 1A is a perspective view of an example spacecraft that includes a main body from which extend a pair of solar arrays.

FIG. 1B is a perspective view of an example lander that includes a main body from which extend a pair of solar arrays.

FIG. 1C is a perspective view of an example rover that includes a main body from which extend a pair of solar arrays.

FIG. 2 is a side view of a portion of an example apparatus (e.g., spacecraft, lander, or rover), according to an embodiment of the present technology, wherein a plurality of piezoelectric elements are attached to a solar array, and a linear actuator is positioned relative to the solar array such that the linear actuator can bump against, or push and pull on, a portion of the solar array.

FIGS. 3 and 4 illustrate how a pair of linear actuators can be used to bump against, or push on and/or pull on, different portions of a support beam of a solar array, in accordance with certain embodiments of the present technology.

FIG. 5 is a high level flow diagram that is used to summarize methods according to various embodiments of the present technology.

### DETAILED DESCRIPTION

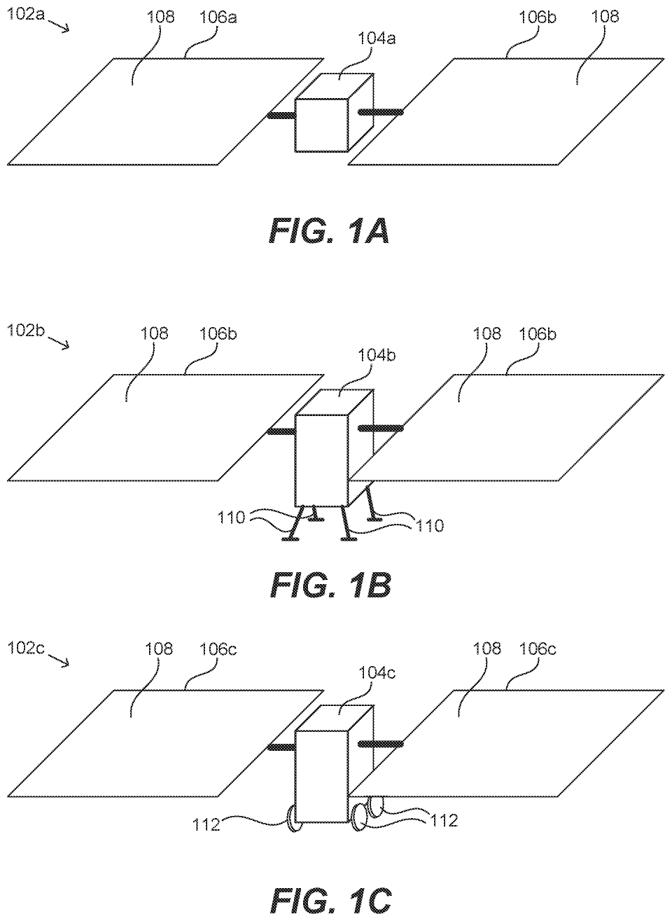

As can be appreciated from FIGS. 1A, 1B, and 1C, solar panels can be used to generate electricity for various different types of apparatuses, such as spacecraft, landers, and rovers, to name a few. For example, FIG. 1A is a perspective view of a spacecraft 102a that includes a main body 104a from which extend a pair of solar arrays 106a. The spacecraft 102a can be, for example, a satellite, a shuttle, a space station, an inter-planet traveling craft, or a rocket, but is not limited thereto. Where the spacecraft 102a is a satellite, it can be, for example, a geostationary or non-geostationary satellite. The main body 104a of the spacecraft 102a can include mechanical and electrical components that are used to control the spacecraft. Additional components not specifically shown can also extend from the main body 104a, such as, but not limited to, thrusters, propellant tanks, and communication antennas.

For another example, FIG. 1B is a perspective view of a lander 102b that includes a main body 104b from which extend a pair of solar arrays 106b. The lander 102b can be, for example, a lunar lander, a Mars lander, or a lander that is designed to land on an asteroid, but is not limited thereto. The main body 104b of the lander 102b can include mechanical and electrical components that are used to control the lander. A plurality of landing legs 110 are shown as extending from the main body 104b of the lander 102b. Additional components not specifically shown can also extend from the main body 104b, such as, but not limited to, thrusters, propellant tanks, and communication antennas.

For still another example, FIG. 1C is a perspective view of a rover 102c that includes a main body 104c from which extend a pair of solar arrays 106c. The rover 102c can be, for example, a lunar rover, a Mars rover, or a rover that is designed to travel on an asteroid, but is not limited thereto. The main body 104c of the rover 102c can include mechanical and electrical components that are used to control the rover 102c. The rover 102c is shown as including a plurality of wheels 112, but can alternatively or additionally include treads, and/or the like, which enable the rover 102c to travel around the Earth's moon, another planet, or an asteroid. Additional components not specifically shown can also extend from the main body 104c, such as, but not limited to, robotic arms and communication antennas.

The spacecraft 102a, the lander 102b, and the rover 102c are example types of apparatuses that include solar arrays that are used to generate electricity for the apparatuses, and can be referred to herein collectively as apparatuses 102, or can be referred to herein individually as an apparatus 102. The main bodies 104a, 104b, and 104c can similarly be referred to collectively as main bodies 104, or individually as a main body 104. Another example of an apparatus that include one or more solar arrays that is/are used to generate electricity for the apparatus is a space habitat that is configured to be erected on a moon, a planet or an asteroid. It is also possible that an apparatus is made up of one or more solar panels, which can include one or more support structures, wherein the apparatus' primary purpose is just to collect and store energy obtained from the sun. For an example, the apparatus can be a standalone solar array, such as, but not limited to, a Lunar Vertical Solar Array Technology (VSAT) solar array.

Similarly, the solar arrays 106a, 106b and 106c can be referred to collectively as solar arrays 106, or individually as a solar array 106. Each of the solar arrays 106 can be made up of one or more solar panels wire in series and/or parallel, with each of the solar panels being made up of several photovoltaic cells. Each of the solar arrays 106 can also include one or more support structures, such as support beams, and/or the like, that are used to hold the solar arrays 106 in their appropriate position relative to a main body 104 and/or relative to the sun. Where a solar array 106 is capable of being transitioned between non-deployed and deployed states, the solar array 106 can also include electrical, mechanical, and/or electromechanical mechanisms that are used perform the transition from the non-deployed state to the deployed state, and potentially also vice versa. While two solar arrays 106 are shown as extending from each of the main bodies 104, more or less than two solar arrays 106 can alternatively extend from each of the main bodies 104. While the shapes of the main bodies 104 in FIGS. 1A, 1B and 1C are generally shown as being rectangular, this is just for simple illustrative purposes. In practice, the shapes of the main bodies can have other shapes, such as cylindrical, or can have more complex shapes than shown. Similarly, the shapes of the solar array 106 while shown as being rectangular, can have other shapes, such as, but not limited to, trapezoidal, triangular, oval, circular, etc. In FIGS. 1A, 1B and 1C, each of the solar arrays 106 is shown as having a respective major planar surface 108 when the solar arrays 106 are in their deployed states. More specifically, each of the solar arrays 106 can include two major planar surfaces that are parallel to one another and face in opposite directions. In other words, each solar array 106 has a pair of opposing major planar surface 108. Solar cells can be located on both of the major planer surfaces of a solar array, or just one of the two major planar surfaces of a solar array, depending on the specific implementation. In FIGS. 1A, 1B and 1C, the solar arrays 106 are shown as generally being in horizontal positions. In other embodiments, one or more of the solar arrays 106 can be in non-horizontal positions, such as in a vertical position or in an angled position (between horizontal and vertical).

In accordance with certain embodiments of the present technology, one or more of the solar arrays 106 can include a flexible blanket solar array that is supported by a frame. In other embodiments, one or more of the solar arrays can include a plurality of rigid or semi-rigid solar panels that are coupled to one another by flexible or semi-flexible hinges. These are just a few examples, which are not intended to be all encompassing, of the types of solar arrays with which embodiments of the present technology can be utilized. Regardless of the type of the solar array, the solar array should typically be capable of being stowed to have a small volume and thereafter be capable of being deployed when needed. For an example, one or more of the solar arrays 106 can be a deployable Roll-Out Solar Array (ROSA) winglet, or can be or be part of a Mega-ROSA solar array system that integrates multiple ROSA winglets into a deployable backbone structure. Each such ROSA winglet includes a flexible solar array that is capable of being rolled into a roll for compact storage when not deployed, and thereafter capable of being deployed by unrolling the flexible solar array when needed. For another example, one or more of the solar arrays 106 can be a foldable solar array that is capable of being folded, e.g., in a Z-fold or accordion fashion for compact storage when not deployed, and capable of being deployed by unfolding the solar array when needed. These are just a few examples of how solar arrays can be stored in compact manners when not deployed and thereafter deployed when needed. Other variations are also possible and within the scope of the embodiments described herein. For example, a solar array can be made up of a plurality of rigid or semi-rigid solar panels that are coupled to one another by flexible or semi-flexible hinges, whereby the solar array can be folded into a compact configuration when not deployed, and then can be unfolded at its hinges to be deployed.

As noted above, solar arrays operating on or near celestial bodies with dusty environments, such as the Earth's moon, Mars, another planet's moon, asteroids, etc., can collect dust which obscures the photovoltaics of such arrays resulting in reduced efficiency, reduced power output and increased temperature, all of which are undesirable. Certain embodiments of the present technology, which are described below, relate to apparatuses, systems and methods that can used to remove dust from solar arrays to thereby improve the efficiency and power output of the solar arrays. Certain such embodiments, as will be described below, use a combination of one or more piezoelectric devices and one or more linear actuators to remove dust from a solar array, wherein such dust can also be referred to herein more generally as particulates. More specifically, in accordance with certain embodiments of the present technology, one or more piezoelectric devices is/are attached to a solar array, and is/are selectively activated to vibrate at least a portion of the solar array to thereby loosen particulates adhered thereto. Additionally, one or more linear actuators is/are configured such that when they are selectively activated the actuator(s) bump against, push on, or pull on the solar array to thereby jettison from the solar array at least some of the particulates that were loosened by the one or more piezoelectric devices. Where the solar array operates on or near the Earth's moon, the particulates can include agglutinates that are vesicular and full of nanophase iron, spherules, volcanic glass beads, mineral fragments, sticky lunar soil, and/or the like. Localized vibrations caused by the one or more piezoelectric devices in combination with sinusoidal excitations of a majority of the solar array caused by the one or more linear actuators should impart sufficient kinetic energy to remove dust and other particulates from the solar array.

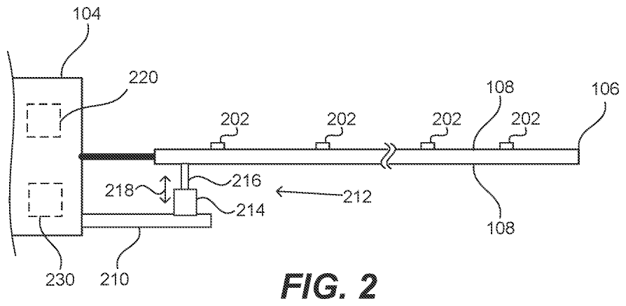

FIG. 2 is a side view of one of the apparatuses 102 introduced above with reference to FIGS. 1A, 1i, and 1C. Shown in FIG. 2 is a side view of a solar array 106 that extends from a side of a main body 104. The main body 104 can be, for example, the main body 104a of a spacecraft 102a, the main body 104b of a lander 102b, or the main body 104c of a rover 102c. The solar array 106 is shown as including a pair of major planar surfaces 108, which include an upper major planar surface 108 and a lower major planar surface 108 that face in opposite directions.

Still referring to FIG. 2, a plurality of piezoelectric devices 202 are attached to the solar array 106. The piezoelectric devices 202, when activated, are configured to vibrate at least a portion of the solar array to thereby loosen particulates, such as dust, that are adhered to the solar array 106, e.g., due to electrostatic forces, or the like. In FIG. 2 the piezoelectric devices 202 are located on one of the major planar surfaces 108 of the solar array 106, but can alternatively be located on both of the major planar surfaces 108.

A support structure 210, such as a buttress, brace or cantilever, extends from the main body 104 and is shown as supporting a linear actuator 212. The linear actuator 212 is shown as including a housing 214 into or relative to which a shaft 216 is linearly actuated in opposing directions indicated by the double-sided arrow 218. The housing 214 of the linear actuator can include a motor or other mechanism that is used to linearly actuate the shaft 216.

Various different types of linear actuators 212 can be used. For example, the linear actuator 212 can be a mechanical linear actuator that converts rotary motion to linear motion, wherein the rotary motion can be provided by a motor within the housing 214. Alternatively, the linear actuator 212 can be a hydraulic linear actuator, wherein the housing 214 is a hollow cylinder having a piston inserted therein, and whereby the linear actuation is provided by linear displacement of the piston. In still other embodiments, the linear actuator 212 is a pneumatic actuator, a piezoelectric actuator, or an electro-mechanical linear actuator. In certain embodiments, the linear actuator 212 is a telescoping linear actuator. Other variations are also possible and within the scope of the embodiments disclosed herein.

Still referring to FIG. 2, in the embodiment shown therein the linear actuator 212 is configured to linearly actuate in a direction generally perpendicular to the major planar surfaces 108 of the solar array 106. As a proximal end of the shaft 216 is linearly actuated relative to housing 214, the distal end of the shaft 216 can be used to bump against, push on, or pull on portion of the solar array 106, as will be described below.

In certain embodiments, a distal end of the shaft 216 is physically uncoupled from the solar array 106 and is moved towards and away from the solar array so that the distal end of the linear actuator 212 bumps against the solar array 106 from time to time (e.g., periodically) when the linear actuator 212 is selectively actuated. In certain such embodiments, each time the distal end of the shaft 216 bumps against the solar array 106 it causes a jolt to the solar array that, depending on the specific type of solar array 106, can cause a sinusoidal oscillation of the solar array 106, such as where the solar array 106 is a flexible blanket solar array, or some other type of flexible or semiflexible solar array. A bumper or spring can be located on the distal end of the shaft 216 to reduce the chance of the linear actuator 212 causing any damage to the solar array. The distal end of the shaft 216 can bump directly against a portion of the solar array 106 that includes cells, or can bump against a support structure of the solar array 106, such as against a support beam. A single linear actuator 212 can be used to bump against the solar array 106. Alternatively, multiple (i.e., two or more) linear actuators 212 can bump against multiple different portions of the solar array 106. For an example, a first linear actuator can bump against a first portion of a support beam of a solar array and a second linear actuator can bump against a second portion of the same support beam of the solar array, so that a tortional force is exerted on the solar array. Where multiple actuators are used, the frequency and phase of the separate actuators can be the same, or can differ from one another. For example, first and second linear actuators can be actuated at a same frequency but 180 degrees (or 45 degrees, 90 degrees, etc.) out of phase with one another. For another example, first and second linear actuators can be actuated at different frequencies than one another.

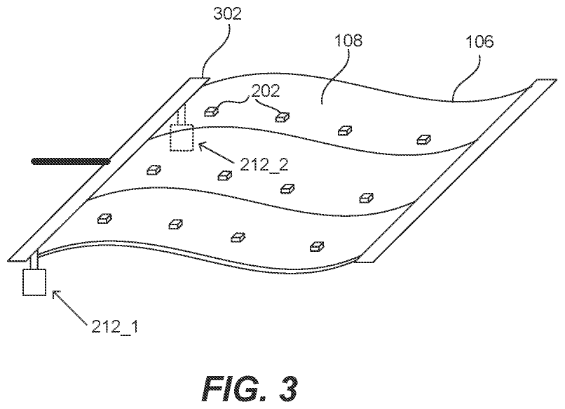

In other embodiments, a distal end of the shaft 216 is physically coupled to the solar array 106 and is moved towards and away from the solar array so that the distal end of the linear actuator 212 pushes on and pulls on the solar array 106 from time to time (e.g., periodically) when the linear actuator 212 is selectively actuated. In certain such embodiments, each time the distal end of the shaft 216 pushes on and pulls on the solar array 106 it causes a sinusoidal oscillation of the solar array 106, such as where the solar array 106 is a flexible blanket solar array, or some other type of flexible or semiflexible solar array. The distal end of the shaft 216 can be physically coupled to a portion of the solar array 106 that includes photovoltaic cells, or physically coupled to a support structure of the solar array 106, such as against a support beam. A single linear actuator 212 can be used to push and pull on the solar array 106. Alternatively, multiple (i.e., two or more) linear actuators 212 can push on and pull on multiple different portions of the solar array 106. Where multiple actuators are used, the frequency and phase of the separate actuators can be the same, or can differ from one another. For example, first and second linear actuators can be actuated at a same frequency in phase with one another. An example of this is shown in FIG. 3, wherein a first linear actuator 202_1 bumps against (or pushes on and pulls on) a first portion of a support beam 302 of a solar array 106, and a second linear actuator 2022 bumps against (or pushes on and pulls on) a second portion of the support beam 302 of the solar array 106 at the same frequency in phase with one another. Where the solar array 106 is a flexible solar panel, such as a flexible blanket solar array, this can cause a sinusoidal wave to travel in in direction along a length of the solar array, e.g., from left to right in FIG. 3.

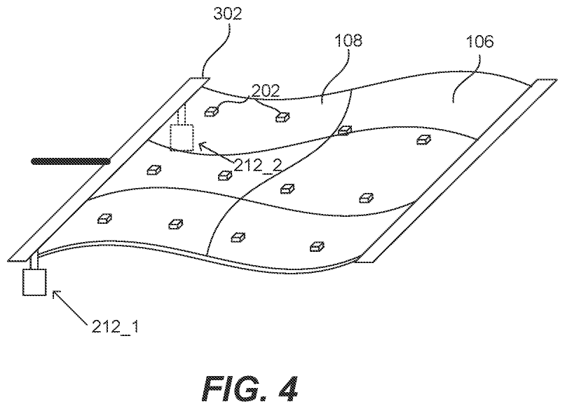

For another example, first and second linear actuators can be actuated at a same frequency but out of phase with one another so that a tortional force is exerted on the solar array. An example of this is shown in FIG. 4, wherein a first linear actuator 202_1 bumps against (or pushes on and pulls on) a first portion of a support beam 302 of a solar array 106, and a second linear actuator 202_2 bumps against (or pushes on and pulls on) a second portion of the support beam 302 of the solar array 106 at the same frequency, but 180 degrees (or 45 degrees, or 90 degrees, etc.) out of phase with one another. Where the solar array 106 is a flexible solar panel, such as a flexible blanket solar array, this can cause a first sinusoidal wave to travel in in a first direction along a first length of the solar array (e.g., from left to right in FIG. 3), and can cause a second sinusoidal wave to travel in a second direction along a second length of the solar array, wherein the second direction and length are generally perpendicular to the first direction and length.

For still another example, the first linear actuator 202_1 can bump against (or push on and pull on) a first portion of the support beam 302 of the solar array 106 at a first frequency and the second linear actuator 202_2 can bump against (or push on and pull on) a second portion of the same support beam 302 of the solar array 106 at a second frequency that differs from the first frequency. Other variations are also possible and within the scope of the embodiments described herein. It is also within the scope of certain embodiments for the one or more linear actuators, which bump against, push on, or pull on portion of a solar array, to linearly actuate in a direction that is not generally perpendicular to a major planar surfaces of the solar array.

Depending upon the type of the linear actuator(s) 212, the motor, piston, or other mechanism for actuating the actuator can be under the control of a controller 220, which can be or include a processor, a state machine, an application specific integrated circuit (ASIC), a field programmable gate array (FPGA), and/or the like. Such a controller 220 can be located within or be otherwise attached to the main body 104 of the apparatus 102 that includes the solar array 106. In certain embodiments, the linear actuator(s) 212 and the piezoelectric devices 202 are powered by a same battery (e.g., 230 in FIG. 2) that is charged by the solar array 106.

In certain embodiments, as noted above, the linear actuator(s) 212 is/are configured to linearly actuate in a direction generally perpendicular to the major planar surfaces 108 of the solar array 106. In other embodiments, the linear actuator(s) 212 can be configured to linearly actuate in a direction that is not generally perpendicular to the major planar surfaces 108 of the solar array 106, e.g., at an obtuse angle or an acute angle relative to the major planar surfaces 108 of the solar array 106, but not limited thereto.

The piezoelectric devices 202, which are attached to the solar array 106, when activated are configured to vibrate at least a portion of the solar array 106 to thereby loosen particulates adhered thereto. While it within the scope of an embodiment that as few as one piezoelectric device 202 can be attached to the solar array, it would be more beneficial if a plurality of piezoelectric devices 202 were distributed onto and across at least one of the major planar surfaces 108 of the solar array so that the piezoelectric devices can be used to vibrate the entire, or substantially the entire, portion of the solar array that includes photovoltaic cells. Since the piezoelectric devices 202 are configured to vibrate when activated they can be referred to more specifically as piezoelectric vibrator devices 202, or as piezoelectric vibrators 202. The linear actuator(s) 212, when actuated, is/are configured to at least one of bump against, push on, or pull on the solar array 106 to thereby jettison from the solar array at least some of the particulates that were loosened by the piezoelectric devices 202.

It is believed that if just the piezoelectric devices 202 were relied upon to remove particulates from a solar array 106, most of the particulates would settle back onto a surface of the solar array, thereby not providing sufficient removal of the particulates. It is also believed that if just one or more linear actuators 212 were relied upon to remove particulates from a solar array 106, by bumping against, pushing on, or pulling on the solar array, a significant amount of the particulates would remain on the solar array because the linear actuator(s) alone would likely be unable to overcome the electrostatic charges that cause the particulates to adhere to the solar array. It is believed that the combination of the use of the piezoelectric device(s) 202 and the use of the linear actuator(s) 212 should provide for significantly better removal of particulates, compared to if just the piezoelectric device(s) 202 or just the linear actuator(s) 212 were relied upon to remove the particulates.

In accordance with certain embodiments, the controller 220 activates the one or more piezoelectric devices 202 at one or more frequencies within a first frequency range, and actuates the one or more linear actuators 212 at one or more frequencies within a second frequency range that is less than the first frequency range. In specific embodiments, the controller 220 activates the one or more piezoelectric devices 202 at one or more frequencies within a first frequency range, and actuates the one or more linear actuators 212 at one or more frequencies within a second frequency range that is at least an order of magnitude less than the first frequency range. For an example, the piezoelectric device(s) 202 can be vibrated at a frequency within the range of 100 Hz to 1000 Hz, and the linear actuator(s) 212 can be actuated at a frequency within the range of 3 Hz to 10 Hz, but not limited thereto. It would also be possible to vibrate the piezoelectric devices 202 at high frequencies, such as at ultrasonic frequencies, but not limited thereto. Vibration of a piezoelectric device 202 can also be referred to herein as activation of a piezoelectric device 202. Similarly, actuation of a linear actuator 212 can also be referred to herein as activation of the linear actuator 212.

The controller 220 can be configured to activate the piezoelectric devices 202 during a first period of time, and to actuate the one or more linear actuators 212 during a second period of time that follows the first period of time. For an example, the piezoelectric devices 202 can be activated for 20 seconds, and then the one or more linear actuators 212 can be actuated for the following 20 seconds. In this most recent example, the first and second periods of time were described as being equal in length, however that need not be the case. For another example, the piezoelectric devices 202 can be activated for 10 seconds, and then the one or more linear actuators 212 can be actuated for the following 30 seconds. Following the second period of time (during which the one or more linear actuators 212 is/are actuated), the piezoelectric devices 202 can again be immediately activated for another first period of time, and then the linear actuator(s) 212 can again be actuated for another second period of time. Alternatively, to conserve power, there could be a deadtime following each second period of time, during which neither the piezoelectric devices 202 nor the linear actuator(s) 212 are activated. In still another embodiment, the controller 220 is configured to activate the piezoelectric devices 202 and to actuate the one or more linear actuators 212 during a same period of time. For example, the controller 220 can activate the piezoelectric devices 202 and actuate the one or more linear actuators 212 for a first period of time, and then during a second period of time that follows the first period of time neither the piezoelectric devices 202 nor the linear actuator(s) 212 are activated.

As noted above, in certain embodiments, the linear actuator(s) 212 and the piezoelectric device(s) 202 are powered by a same battery 230 that is charged by the solar array 106. In certain such embodiments, the controller 220 selectively activates the piezoelectric device(s) 202 and selectively actuates the linear actuator(s) 212 so that an increase in an amount of power collected by the solar array 106, which results from the jettison of the at least some of the particulates from the solar array 106, exceeds an amount of power consumed to activate the piezoelectric device(s) 202 and to actuate the linear actuator(s) 212. In order to do this, the controller 220 can monitor the energy collection and/or efficiency of the solar array 106, and can determine when it would be beneficial to activate the piezoelectric device(s) 202 and to actuate the linear actuator(s) 212, assuming the controller knows how much energy it takes to activate the piezoelectric device(s) 202 and to actuate the linear actuator(s) 212. In a relatively simple embodiment, the controller 220 can activate the piezoelectric device(s) 202 and actuate the linear actuator(s) 212 in response to a monitored metric falling below a threshold. For an example, the monitored metric can be an energy collection rate and the threshold can be an energy collection rate threshold. For another example, the monitored metric can be an energy collection efficiency and the threshold can be an energy collection efficiency threshold. These are just a few examples which are not intended to be all encompassing. In somewhat more complex embodiments, the controller 220 can use an algorithm or machine learning to predict when it would be beneficial to activate the piezoelectric device(s) 202 and actuate the linear actuator(s) 212. For an example, the controller 220 can use machine learning or an algorithm to predict when activation of the piezoelectric device(s) 202 and actuation of the linear actuator(s) 212 will result in removal of a sufficient amount of the particulates from the solar array 106, such that there is an increase in an amount of power collected by the solar array 106 that exceeds the amount of power consumed to activate the piezoelectric device(s) 202 and to actuate the linear actuator(s) 212. Other variations are also possible and within the scope of the embodiments described herein.

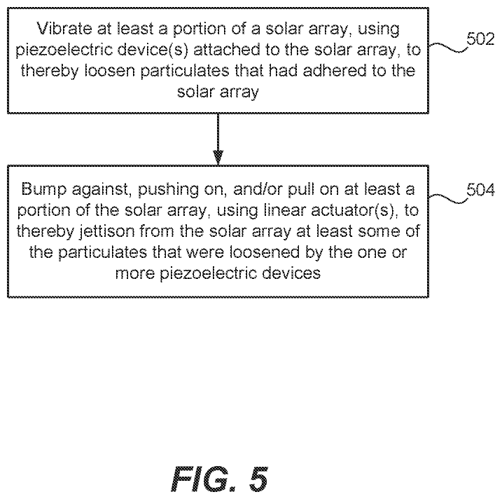

The high level flow diagram of FIG. 5 will now be used to summarize methods according to certain embodiments of the present technology, which can be used to remove particulates from a solar array of a spacecraft, a rover or a lander, but not limited thereto. Referring to FIG. 5, step 502 involves vibrating at least a portion of the solar array, using one or more piezoelectric devices attached to the solar array, to thereby loosen particulates that had adhered to the solar array. Still referring to FIG. 5, step 504 involves at least one of bumping against, pushing on, or pulling on a portion of the solar array, using one or more linear actuators, to thereby jettison from the solar array at least some of the particulates that were loosened by the one or more piezoelectric devices.

In accordance with certain embodiments, step 502 is performed during a first period of time, and step 504 is performed during a second period of time that follows the first period of time. This can be achieved by activating the one or more piezoelectric devices during the first period of time, and by actuating the one or more linear actuators during the second period of time that follows the first period of time. In accordance with other embodiments, step 502 and step 504 are performed during a same period of time. This can be achieved by simultaneously activating the one or more piezoelectric devices and actuating the one or more linear actuators. In accordance with certain embodiments, steps 502 and 504 are performed under the control of a controller (e.g., 214).

In accordance with certain embodiments, the bumping against, pushing on, or pulling on a portion of the solar array, using the one or more linear actuators, is performed in a respective direction generally perpendicular to a major planar surface of the solar array, e.g., as was initially described above with reference to FIG. 2.

In certain embodiments, step 504 is performed using a first linear actuator and a second linear actuator, whereby the first linear actuator (e.g., 2121) bumps against, pushes on, and/or pulls on a first portion of the solar array (e.g., 106), and whereby the second linear actuator (e.g., 212_2) bumps against, pushes on, or pulls on a second portion of the solar array, so that a tortional force is exerted on the solar array.

In certain embodiments, the vibrating at step 502 is performed by activating the one or more piezoelectric devices at one or more frequencies within a first frequency range, and step 504 is performed by actuating the one or more linear actuators at one or more frequencies within a second frequency range that is less than the first frequency range. In certain embodiments, the second frequency range is at least an order of magnitude less than the first frequency range.

In certain embodiments, where the solar array is a flexible blanket solar array that is supported by a frame, and the portion of the solar array, upon which the at least one of bumping against, pushing on, or pulling on occurs, is the frame that supports the flexible blanket solar array.

In FIGS. 1A, 1B and 1C, the solar arrays 106 were shown as generally being in horizontal positions. As noted above, in other embodiments, one or more of the solar arrays 106 can be in non-horizontal positions, such as in a vertical position or an angled position (between horizontal and vertical). Where a solar array 106 is in a vertical position or an angled position (between horizontal and vertical), gravity can also assist in removing particulates from the solar array 106 once the particulates are loosened using an embodiment of the present technology.

Embodiments of the present technology have been described above with the aid of functional building blocks illustrating the performance of specified functions and relationships thereof. The boundaries of these functional building blocks have often been defined herein for the convenience of the description. Alternate boundaries can be defined so long as the specified functions and relationships thereof are appropriately performed. Any such alternate boundaries are thus within the scope and spirit of the claimed invention. For example, it would be possible to combine or separate some of the steps described above.

The disclosure has been described in conjunction with various embodiments. However, other variations and modifications to the disclosed embodiments can be understood and effected from a study of the drawings, the disclosure, and the appended claims, and such variations and modifications are to be interpreted as being encompassed by the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate, preclude or suggest that a combination of these measures cannot be used to advantage.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the above detailed description of the present subject matter, numerous specific details are set forth in order to provide a thorough understanding of the present subject matter. However, it will be clear to those of ordinary skill in the art that the present subject matter may be practiced without such specific details.

For purposes of this document, it should be noted that the dimensions of the various features depicted in the figures may not necessarily be drawn to scale.

For purposes of this document, reference in the specification to “an embodiment,” “one embodiment,” “some embodiments,” or “another embodiment” may be used to describe different embodiments or the same embodiment.

For purposes of this document, without additional context, use of numerical terms such as a “first” object, a “second” object, and a “third” object may not imply an ordering of objects, but may instead be used for identification purposes to identify different objects.

The foregoing detailed description has been presented for purposes of illustration and description. It is not intended to be exhaustive or to limit the subject matter claimed herein to the precise form(s) disclosed. Many modifications and variations are possible in light of the above teachings. The described embodiments were chosen in order to best explain the principles of the disclosed technology and its practical application to thereby enable others skilled in the art to best utilize the technology in various embodiments and with various modifications as are suited to the particular use contemplated. It is intended that the scope be defined by the claims appended hereto.

The previous description of the preferred embodiments is provided to enable any person skilled in the art to make or use the embodiments of the present invention. While the invention has been particularly shown and described with reference to preferred embodiments thereof, it will be understood by those skilled in the art that various changes in form and details may be made therein without departing from the spirit and scope of the invention.

1. An apparatus, comprising:
a solar array;
one or more piezoelectric devices attached to the solar array and that when activated is/are configured to vibrate at least a portion of the solar array to thereby loosen particulates adhered thereto; and
one or more linear actuators that when actuated is/are configured to at least one of bump against, push on, or pull on at least a portion of the solar array to thereby jettison from the solar array at least some of the particulates that were loosened by the one or more piezoelectric devices.

2. The apparatus of claim 1, wherein the one or more linear actuators is/are each configured to linearly actuate in a respective direction generally perpendicular to a major planar surface of the solar array.

3. The apparatus of claim 2, wherein:
the one or more linear actuators include a first linear actuator and a second linear actuator; and
the first linear actuator is configured to bump against, push on, or pull on a first portion of the solar array, and the second linear actuator is configured to bump against, push on, or pull on a second portion of the solar array, so that a tortional force is exerted on the solar array.

4. The apparatus of claim 1, further comprising:
a controller configured to selectively activate the one or more piezoelectric devices and to selectively actuate the one or more linear actuators.

5. The apparatus of claim 4, wherein the controller is configured to activate the one or more piezoelectric devices at one or more frequencies within a first frequency range, and to actuate the one or more linear actuators at one or more frequencies within a second frequency range that is less than the first frequency range.

6. The apparatus of claim 4, wherein the controller is configured to activate the one or more piezoelectric devices during a first period of time and to actuate the one or more linear actuators during a second period of time that follows the first period of time.

7. The apparatus of claim 4, wherein the controller is configured to activate the one or more piezoelectric devices and to actuate the one or more linear actuators during a same period of time.

8. The apparatus of claim 4, wherein the controller is configured to selectively activate the one or more piezoelectric devices and to selectively actuate the one or more linear actuators so that an increase in an amount of power collected by the solar array, which results from the jettison of the at least some of the particulates from the solar array, exceeds an amount of power consumed to activate the one or more piezoelectric devices and to actuate the one or more linear actuators.

9. The apparatus of claim 1, wherein:
the solar array comprises a flexible blanket solar array that is supported by a frame; and
the one or more linear actuators, when actuated, is/are configured to at least one of bump against, push on, or pull on one or more portions of the frame that supports the flexible blanket solar array.

10. The apparatus of claim 1, wherein the solar array comprises a plurality of rigid or semi-rigid solar panels that are coupled to one another by flexible or semi-flexible hinges.

11. The apparatus of claim 1, wherein the apparatus further comprises a main body from which the solar array extends, and wherein the main body comprises a portion of one of the following:
a lander configured to land on a moon, a planet, or an asteroid;
a rover configured to drive on a moon, a planet, or an asteroid; or
a spacecraft configured to orbit a moon or a planet.

12. A method for removing particulates from a solar array, the method comprising:
vibrating at least a portion of the solar array, using one or more piezoelectric devices attached to the solar array, to thereby loosen particulates that had adhered to the solar array; and
at least one of bumping against, pushing on, or pulling on at least a portion of the solar array, using one or more linear actuators, to thereby jettison from the solar array at least some of the particulates that were loosened by the one or more piezoelectric devices.

13. The method of claim 12, wherein the at least one of bumping against, pushing on, or pulling on a portion of the solar array, using the one or more linear actuators, is performed in a respective direction generally perpendicular to a major planar surface of the solar array.

14. The method of claim 13, wherein the one or more linear actuators include a first linear actuator and a second linear actuator, and wherein the at least one of bumping against, pushing on, or pulling on a portion of the solar array, using the one or more linear actuators comprises:
at least one of bumping against, pushing on, or pulling on a first portion of the solar array using the first linear actuator, and at least one of bumping against, pushing on, or pulling on a second portion of the solar array using the second linear actuator, so that a tortional force is exerted on the solar array.

15. The method of claim 12, wherein:
the vibrating is performed by activating the one or more piezoelectric devices at one or more frequencies within a first frequency range; and
the at least one of bumping against, pushing on, or pulling on a portion of the solar array is performed by actuating the one or more linear actuators at one or more frequencies within a second frequency range that is less than the first frequency range.

16. The method of claim 12, wherein:
the vibrating is performed by activating the one or more piezoelectric devices during a first period of time; and
the at least one of bumping against, pushing on, or pulling on a portion of the solar array is performed by actuating the one or more linear actuators during a second period of time that follows the first period of time.

17. The method of claim 12, wherein the vibrating and the at least one of bumping against, pushing on, or pulling on a portion of the solar array are performed during a same period of time by activating the one or more piezoelectric devices and actuating the one or more linear actuators during the same period of time.

18. The method of claim 12, wherein the vibrating and the at least one of bumping against, pushing on, or pulling on a portion of the solar array are selectively performed so that an increase in an amount of power collected by the solar array, which results from the jettison of the at least some of the particulates from the solar array, exceeds an amount of power consumed to activate the one or more piezoelectric devices and to actuate the one or more linear actuators.

19. The method of claim 12, wherein the solar array comprises a flexible blanket solar array that is supported by a frame, and wherein the portion of the solar array, upon which the at least one of bumping against, pushing on, or pulling on occurs, comprises the frame that supports the flexible blanket solar array.

20. The method of claim 12, wherein the solar array comprises a plurality of rigid or semi-rigid solar panels that are coupled to one another by flexible or semi-flexible hinges.

21. An apparatus, comprising
a flexible blanket solar array;
a frame that supports the flexible solar array blanket;
a plurality of piezoelectric devices attached to the flexible solar array blanket;
one or more linear actuators positioned so that the one or more linear actuators each linearly actuate in a respective direction generally perpendicular to a major planar surface of the solar array, and such that each can at least one of bump against, push on, or pull on the frame that supports the flexible solar array blanket; and
a controller configured to cause selective activation of the plurality of piezoelectric devices attached to the solar array to thereby vibrate at least a portion of the solar array to thereby loosen particulates adhered thereto; and
the controller also configured to cause selective actuation of the one or more linear actuators so that the one or more linear actuators at least one of bump against, push on, or pull on the frame that supports the flexible solar array blanket to thereby jettison from the flexible solar array blanked at least some of the particulates that were loosened by the plurality of piezoelectric devices.

22. The apparatus of claim 1, wherein the solar array comprises a deployable roll-out solar array winglet.
